(19) United States
(12) Patent Application Publication
(10) Pub. No.: US 2013/0118085 A1
(43) Pub. Date: May 16, 2013

(54) FOOT OPERATED SANITARY DOOR OPENER

(71) Applicant: Paul Hedemark, Mason, MI (US)

(72) Inventor: Paul Hedemark, Mason, MI (US)

(21) Appl. No.: 13/672,467

(22) Filed: Nov. 8, 2012

Related U.S. Application Data
(60) Provisional application No. 61/558,073, filed on Nov. 10, 2011.

(51) Int. Cl. E05F 11/54; F16H 21/44; E06B 1/52

(52) U.S. Cl. CPC E05F 11/54; E06B 1/52; F16H 21/44
USPC 49/356; 49/504; 74/102

(57) ABSTRACT

A foot-operated sanitary door opener for a door supported in a door frame for swinging movement between open and closed conditions. A foot pedal is attached to the door frame. A strike pad is disposed in a pocket of the stop strip portion of the door frame. When depressed, the foot pedal imparts movement to the strike pad, which in turn thrusts open the door. In one embodiment, the foot pedal is guided for linear movement between its home and actuated conditions. In one embodiment, a retrofit mounting bracket enables a flush fit installation with respect to the swing side of the door frame. Various linkage arrangements are proposed to achieve pivotal, linear and other motions of the strike pad.

### CROSS REFERENCE TO RELATED APPLICATIONS

This application claims priority to Provisional Patent Application No. 61/558,073 filed Nov. 10, 2011, the entire disclosure of which is hereby incorporated by reference and relied upon.

### BACKGROUND OF THE INVENTION

1. Field of the Invention

A foot-operated sanitary door opener assembly for a door supported in a door frame for swinging movement between open and closed conditions.

2. Related Art

It is estimated in the United States that one-third of public restroom/lavatory users do not wash their hands before exiting. The remaining two-thirds of public restroom users, i.e., those who do regularly wash their hands and thus can be presumed to have at least some concern about proper hygiene, are often reluctant to touch the door handle due to the potential for germ transfer. Through several independent studies, it has been determined that the average restroom door handle in a public facility is contaminated with disease-causing genus. This issue is not only relevant to patrons, but also to managers of food service businesses whose food handling employees use a restroom while at work. Further, the issue is relevant to employers of non-food service enterprises that would welcome methods to minimize losses due to employee sick time. And still further, public health agencies are concerned always about the spread of disease.

Public restroom users have, sua sponte, devised numerous strategies to avoid touching a public restroom door handle upon exit. One common strategy is to utilize a paper towel to grip the door handle. The paper towel is usually discarded in the restroom upon exit, which accounts for a large source of waste accumulation in the restroom. Such use of paper towels adds to the consumables expense of a business. Furthermore, in bathrooms that utilize electric hand dryers, paper towels might not be available. Another strategy employed by many public restroom patrons is the so-called “pinky pull” method in which the person uses only the pinky finger (typically of their weaker hand) to open the door far enough to allow a foot or elbow or lee to take hold of the door and open it for egress. The pinky pull method is particularly difficult for people with arthritis or weak pinky fingers. Furthermore, the pinky pull method does not prevent the transfer germs residing upon the door handle. Indeed, germs transferred to the pinky finger can eventually spread contamination.

Manufactured strategies include the attachment of a forearm hook to the face of an in-swinging door such as shown, for example, in U.S. Pat. No. 4,817,239 to Campbell et al. issued Apr. 4, 1989, and a hygienic door handle offered by Pureleve of Glendale, Wis. The Pureleve hygienic door handle employs a sleeve dispenser that automatically advances an antimicrobial material to cover the handle, providing a fresh, sanitary touch after every use. Hygienic door handles like that suggested by Pureleve are expensive, complicated, and require a power supply and continual maintenance in the form of replacing the antimicrobial film. This increases landfill content and cost to restaurants and other facilities that maintain public restrooms.

The prior art has proposed several devices to enable a door to be opened by foot rather than hand. Toe hook and toe catch devices are shown for example in U.S. Pat. No. 7,043,799 to Moody issued May 16, 2006 as well as the product marketed under the Trademark StepNpull as described in their website at www.stepnpull.com. The foot operated pulls have numerous drawbacks. One drawback is that the user must carefully position their foot in the swinging path of the door and then use leg muscles to awkwardly drag the door open. If a person on the other (i.e., posterior) side of the door attempts to enter the restroom at the same time, a sharp blow may be delivered to patron's foot causing possible injury. Another disadvantage of toe hook products is that the leg muscles needed to drag open a door in a pulling motion are somewhat unnatural and often difficult for the task of opening a heavy public restroom door. People particularly of older age or infirmity could pull a groin muscle or slip in the process.

In contrast to the foot operated door pulls, the prior art has also taught the use of foot pedal operated door levers or throws. Examples of foot pedal door openers include U.S. Pat. Nos. 732,729 to Lee granted Jun. 14, 1904 and 1,244,910 to Smith granted 1917. These devices support a foot pedal on a pivoting support at the swing side of a door frame and include a strike pad that pushes the door open in direct response to depression of the foot pedal. A spring return feature is included to automatically reset the foot pedal to its elevated home position. The prior art foot pedal door openers have many disadvantages. These disadvantages include a generally unsightly appearance. As will be appreciated, public restrooms often reflect (for good or bad) upon the quality of the host establishment. A dirty restroom and/or restroom fitted with cheap or malfunctioning hardware will cause patrons to apply a similar perception on the owners/managers of the premises. For this reason, an unsightly foot pedal door openers is likely to be rejected by a conscientious host establishment despite its functionality. Another drawback of the prior art foot pedal door openers include their difficulty to keep clean over time. Public restrooms can be very dirty places, especially near the floor. Public restroom floors are frequently mopped using large quantities of water and detergents. The large quantity of washing fluids, in combination with the rapid grime build-up common near the floor of a public restroom, make the prior art foot pedal door openers a breeding ground for contamination and/or corrosion. Still further prior art foot pedal door openers are often configured so that they protrude substantially into the pass-through area of the doorway and/or into the walking areas of the restroom. Such ungainly protrusion represents a tripping hazard, and can threaten non-compliance with minimum clearances and code requirements established by the Americans with Disabilities Act (ADA) and other regulating bodies. Still further, the pivotal travel of prior art foot pedal door openers requires a relatively long or large arc of movement in order to achieve a suitable displacement of the strike pad feature to open a door. This large are of movement translates to a relatively large extension of the foot pedal out from the wall or door frame thus creating tripping hazards and threatening non-compliance with code requirements.

Despite the numerous prior art attempts to address the problem of sanitary door exits, there remains a need for an improved system that is easy to use, relatively inexpensive, robust and easy to install in retrofit applications as well as in new door installation scenarios.

### SUMMARY OF THE INVENTION

According to one aspect of this invention, a foot-operated sanitary door opener assembly is provided for a door of the type supported in a door frame for swinging movement between open and closed conditions. The assembly includes a stop strip. A foot pedal is moveably supported relative to the stop strip. The foot pedal has an elevated home position and a descended actuated condition. A strike pad is operatively connected to the foot pedal, and is configured to impart movement to the door in response to movement of the foot pedal. The strike pad has a retracted condition corresponding to the home position of the foot pedal and an extended condition corresponding to the actuated condition of the foot pedal. The improvement comprises a pocket defined by the stop strip. The strike pad is disposed in the pocket in its retracted condition, and at least partially disposed outside the pocket in its extended condition.

According to another aspect of this invention, a foot-operated sanitary door and door frame assembly comprises a door and a door frame configured to support the door for swinging movement between open and closed conditions. The door frame includes a generally vertical swing side adjacent the swinging edge of the door. The swing side of the door frame includes a generally vertically extending jamb face. A stop strip is disposed along the jamb face. A foot pedal is provided which includes a linkage moveably supported relative to the stop strip. The foot pedal has an elevated home position and a descended actuated condition. A strike pad is operatively connected to the linkage, and is configured to impart movement to the door in response to movement of the foot pedal. The strike pad has a retracted condition corresponding to the home position of the foot pedal and an extended condition corresponding to the actuated condition of the foot pedal. The stop strip defines a pocket. The strike pad is disposed in the pocket in the retracted condition, and at least partially disposed outside the pocket in the extended condition.

The pocket feature of the present invention provides a refined appearance, particularly as viewed from the posterior side of the door. The pocket is helpful in reducing protrusion of the strike pad and/or other components of the invention into the pass-through area of the door frame. In other words, the pocket helps to maintain minimum dimensional requires as set by the ADA and other regulatory bodies, while allowing the strike pad to be positioned in an effective location relative to the swinging edge of the door. Furthermore, the pocket helps protect the strike pad and/or other components of the invention from snags and also from cleaning detergents such as during floor mopping routines. The pocket additionally helps to reduce the likelihood that modification to the door will be required when installing the assembly, particularly in retrofit installation situations.

According to a still further aspect of this invention, a foot-operated sanitary door opener assembly is provided for a door of the type supported in a door frame for swinging movement between open and closed conditions. The assembly includes a mounting bracket. A foot pedal is moveably supported relative to the mounting bracket, and has an elevated home position and a descended actuated condition. A strike pad is operatively connected to the linkage. The strike pad is configured to impart movement to the door in response to movement of the foot pedal. The strike pad has a retracted condition corresponding to the home position of the foot pedal and an extended condition corresponding to the actuated condition of the foot pedal. The foot pedal includes a linkage that is effective to establish guided linear movement of the foot pedal between its home and actuated conditions.

Guided linear movement of the foot pedal is advantageous for many reasons. One such reason relates to overall compactness of the assembly. Namely, the vertical pedal motion allows the foot pedal to be located relatively close to the wall or door frame, which in turn means less protrusion into walking spaces. Unlike pivotally mounted pedal systems, vertical pedal travel can be configured to provide a substantial degree of motion input without increasing the protrusion distance from the wall. Another significant advantage of vertical pedal travel is that vertical motion is sometimes considered, on average, to be more user friendly than pivotal pedal travel. This may be especially the case with elderly users who usually do not have as much leg and abdominal strength as younger people.

### BRIEF DESCRIPTION OF THE DRAWINGS

These and other features and advantages of the present invention will become more readily appreciated when considered in connection with the following detailed description and appended drawings, wherein:

FIG. 1 is a perspective view of a restroom door as viewed from inside the restroom, and showing a foot-operated sanitary door opener assembly according to a first embodiment of the present invention;

FIG. 2 is a perspective view of a restroom door as viewed from inside the restroom, but showing the door opening in response to a user depressing the foot pedal;

FIG. 3 is a view as in FIG. 2 but from the perspective of outside the restroom looking in;

FIG. 4 is a side elevation of the lower portion of a swing side of a door frame fitted with a foot-operated sanitary door opener assembly according to the first embodiment of the present invention, and the foot pedal shown in a home position;

FIG. 5 is a view as in FIG. 4 but with the foot pedal shown in an actuated position;

FIG. 6 is cross-sectional view taken generally along lines 6-6 in FIG. 4 with the foot pedal in a home position;

FIG. 7 is cross-sectional view taken generally along lines 7-7 in FIG. 5 with the foot pedal in an actuated position;

FIG. 8 is a perspective view of the assembled door opener assembly as viewed from inside the swing side of the door frame;

FIG. 9 is an exploded view of the strike pad and a portion of the linkage according to the first embodiment to illustrate the replaceable nature of the strike pad;

FIG. 10 depicts an alternative bumper that softly arrests downward travel of the foot pedal;

FIG. 11 is an exploded view of a second alternative embodiment of the invention wherein the mounting bracket is flush mounted with the door frame;

FIG. 12 is a perspective view of a third alternative embodiment wherein the foot pedal is constrained to guided linear movement between its home and actuated conditions, and the linkage features are enclosed within a hollow door frame;

FIG. 13 is a perspective view of the third alternative embodiment from the perspective of outside the restroom;

FIG. 14 is a cutaway view of the third alternative embodiment showing the foot pedal in its home position;

FIG. 15 is a view as in FIG. 14 showing the foot pedal in its actuated position; and

FIG. 16 is a side elevation of the lower portion of a swing side of a door frame fitted with a foot-operated sanitary door opener assembly according to a fourth embodiment of the present invention, wherein the strike pad is guided for non-pivoting movement between its retracted and extended conditions.

### DETAILED DESCRIPTION OF THE PREFERRED EMBODIMENT

Referring to the figures wherein like numerals indicate like or corresponding parts throughout the several views, a door such as for a public restroom is generally indicated at 20. The door 20 may be of any suitable type and construction, shown in the Figures as being a generally rectangular body having an anterior side 22 and an opposite posterior side 24. The terms “anterior” and “posterior” are used herein with respect to a person or user located inside a restroom or otherwise desiring to open the door 20. The door 20 may be of the traditional rectangular body defined by a generally vertical hinge edge 26, a generally vertical swinging edge 28, a generally horizontal top edge 30 and a generally horizontal bottom edge 32.

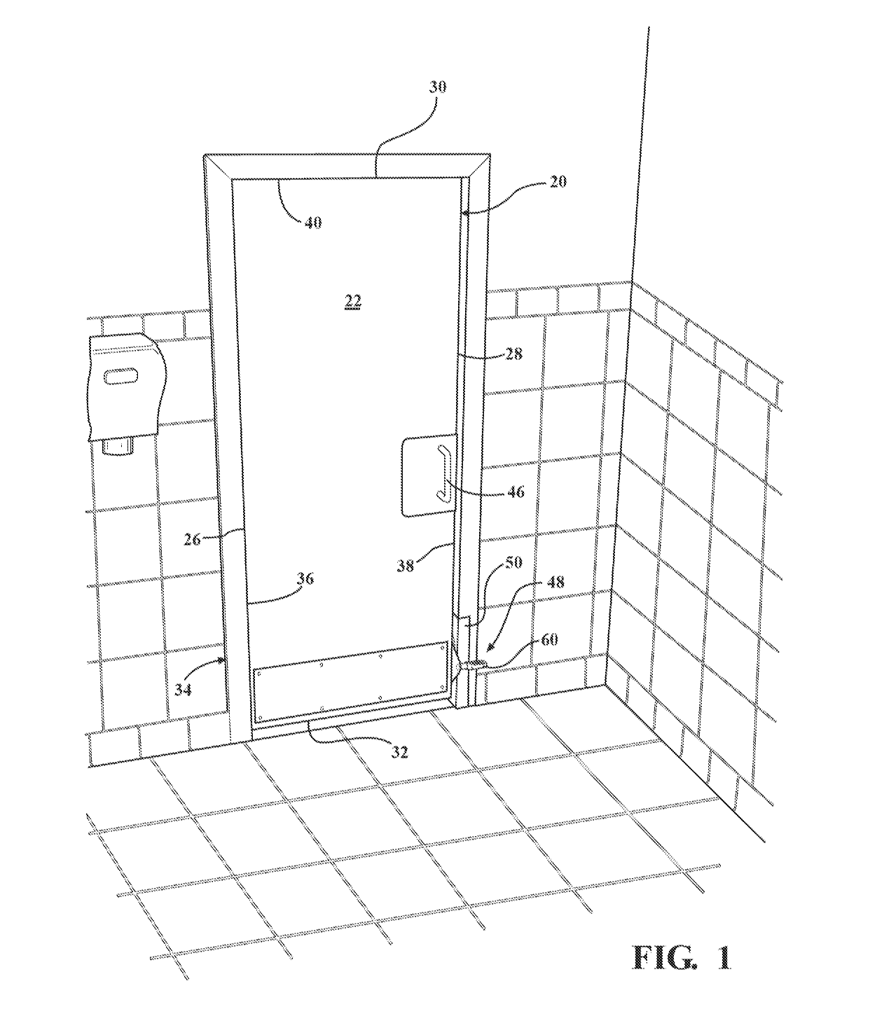

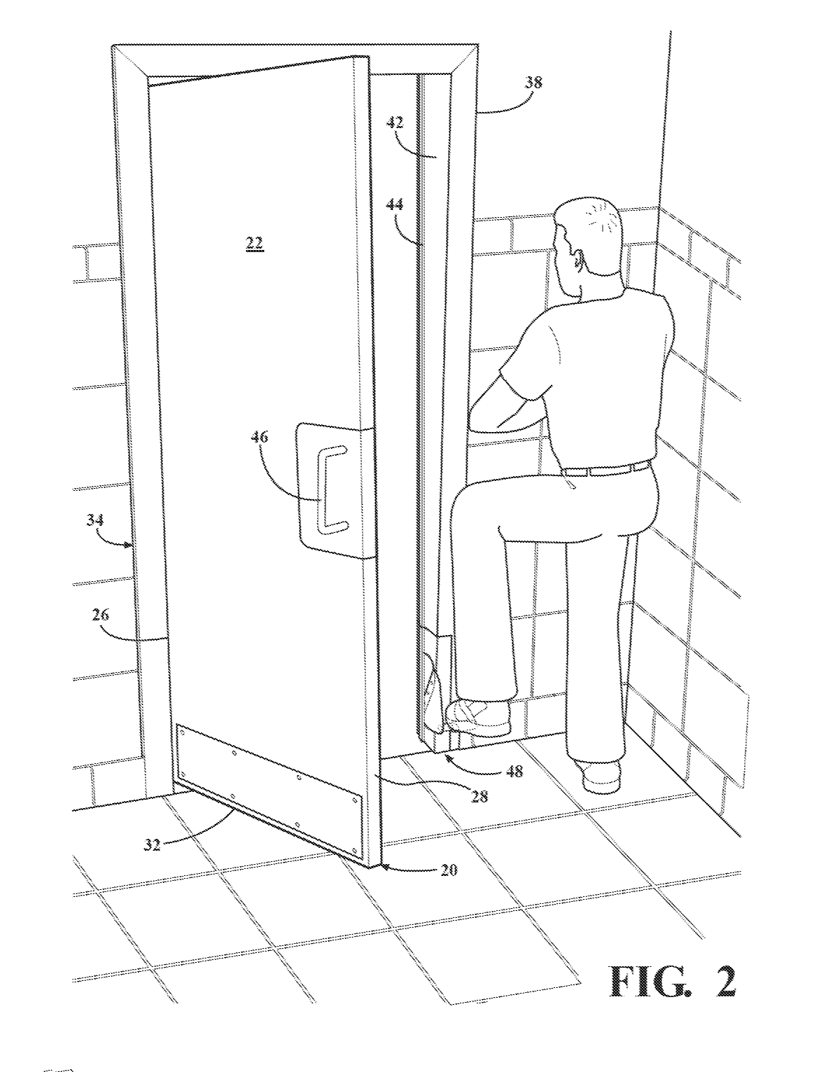

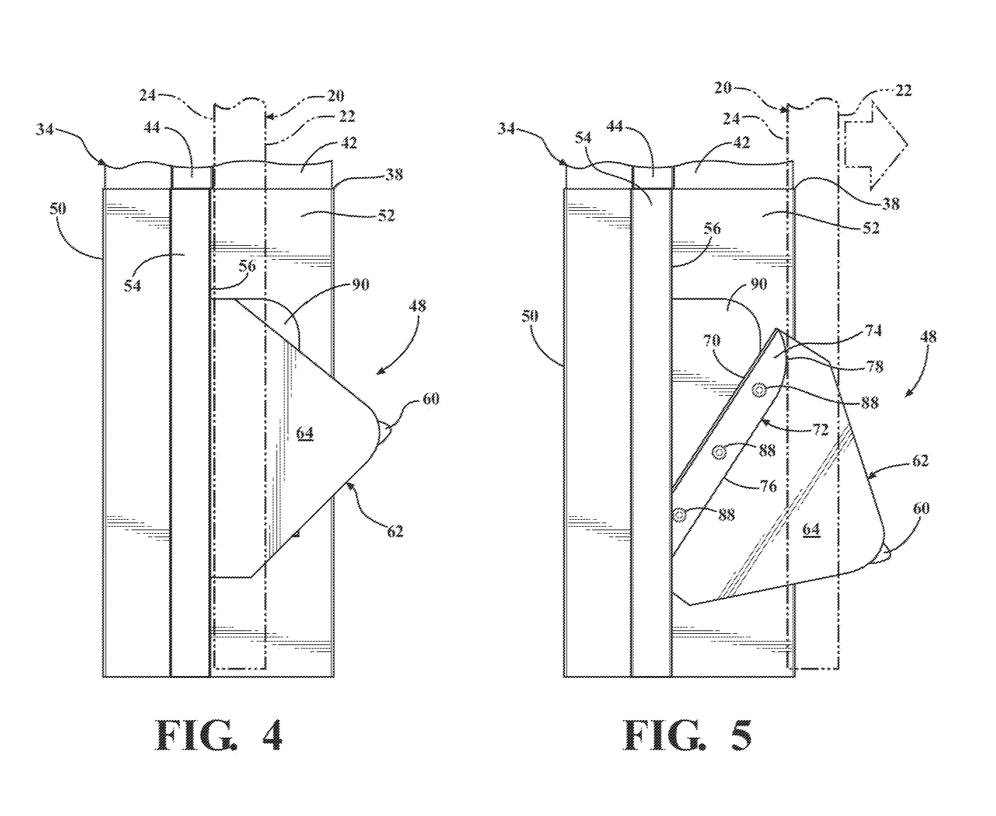

The door 20 is supported in the customary fashion in a door frame, generally indicated at 34, for swinging movement between open and closed conditions. The door 20 is shown “closed” with respect to the door frame 34 in FIGS. 1, 4 and 6, and “open” with respect to the door frame 34 in FIGS. 2, 3, 5 and 7. The door frame 34 may also take various forms depending on the application, but is shown throughout the figures in a typical commercial implementation having a vertical hinge side 36 adjacent the hinge edge 26 of the door 20, and a vertical swing side 38 adjacent the swinging edge 28 of the door 20, and a horizontal transom side 40 adjacent the top edge 30 of the door 20.

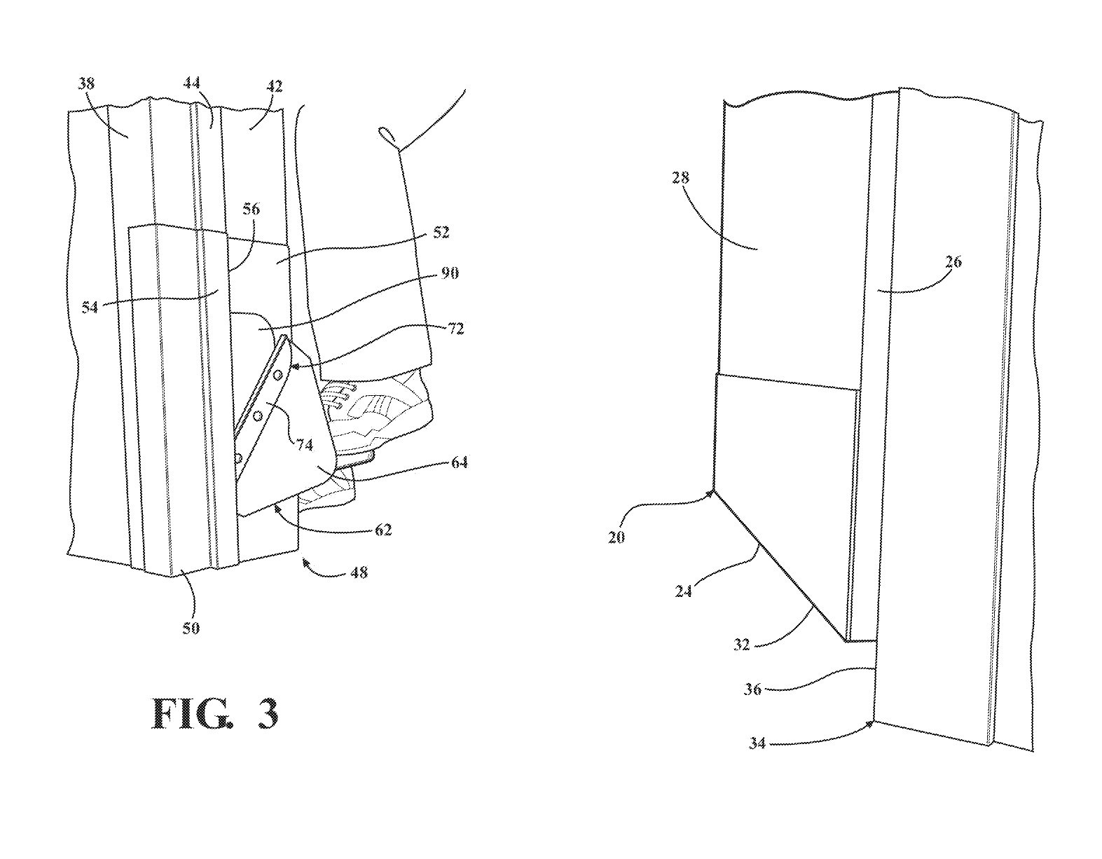

More specifically referring to the swing side 38 of the frame 34, as perhaps best shown in FIG. 3, a generally vertically extending jamb face 42 establishes an inner portion of the pass-through area. A stop strip 44 is disposed generally centrally along the jamb face 42. The stop strip 44, which can be located closer to the anterior or posterior side of the frame 34 depending on design choice and other factors, establishes an abutment plane with which the posterior side 24 of the door 20 aligns when the door 20 is in a closed position. The stop strip 44 is commonly formed from a piece of shaped wood trim or, in the case of metal frames 34, an integral deformation in the sheet-like material as shown in several of the Figures. Typically, the stop strip 44 has a generally uniform width and a generally uniform projection from the jamb face 42. Similar jamb face and stop strip features are commonly found on the hinge side 36 and transom side 40 of the door frame 34, but such are not relevant to the discussion of this present invention.

A plurality of door hinges (not shown) are operatively disposed between the hinge side 36 of the door frame 34 and the hinge edge 26 of the door 20. In well-known fashion, the door hinges cooperate to support the door 20 in the frame 34 for pivotal movement toward and away from the closed condition in which its posterior side 24 is generally aligned with the abutment plane of the stop strip 44 and the swinging edge 28 of the door 20 is in direct contact with the stop strip 44.

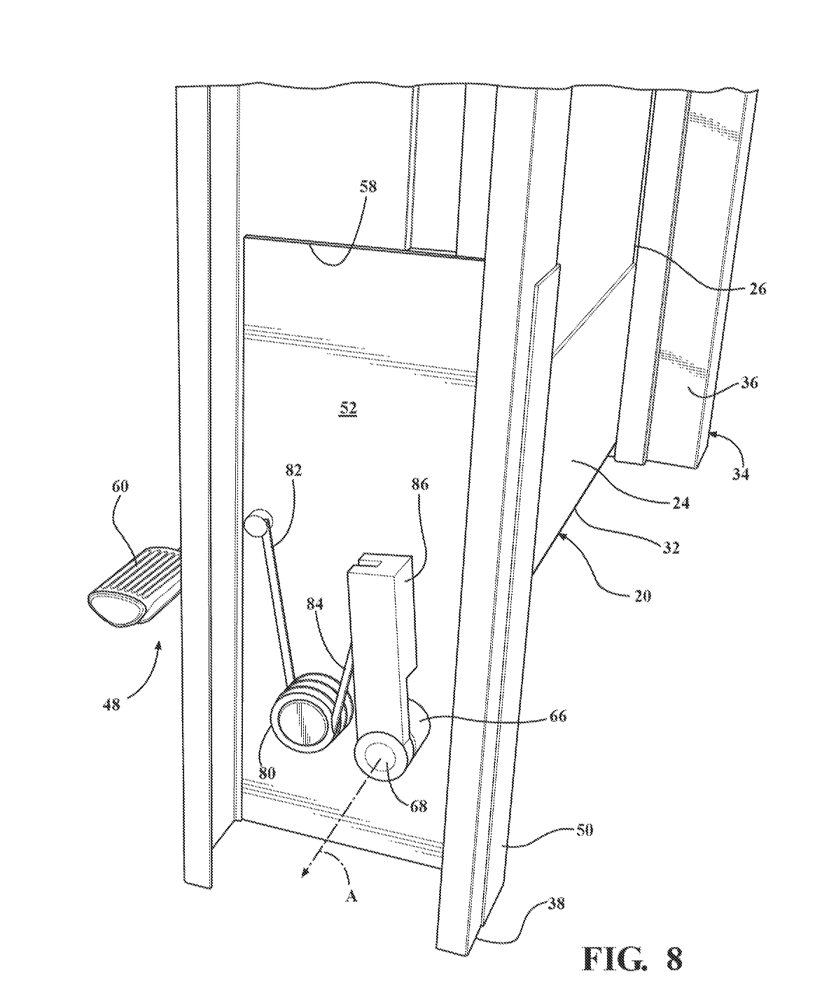

As shown in FIG. 1, the door 20 may include a pull handle 46 so that a user can manually pull open the door 20 in the customary fashion upon exiting through the frame 34. As an alternative opening the door 20 by the traditional pull handle 46, a user may elect to open the door 20 using a foot-operated sanitary door assembly according to the present invention. A first embodiment of the foot-operated door assembly is generally indicated at 48 in FIGS. 1-12. The assembly 48 may either be configured as an attachment feature, such as in retrofit installation applications, or integrated into a hollow door frame 34 as in commercial Original Equipment (OE) applications. Naturally, the invention can be implemented in all types of settings, including residential and non-restroom uses.

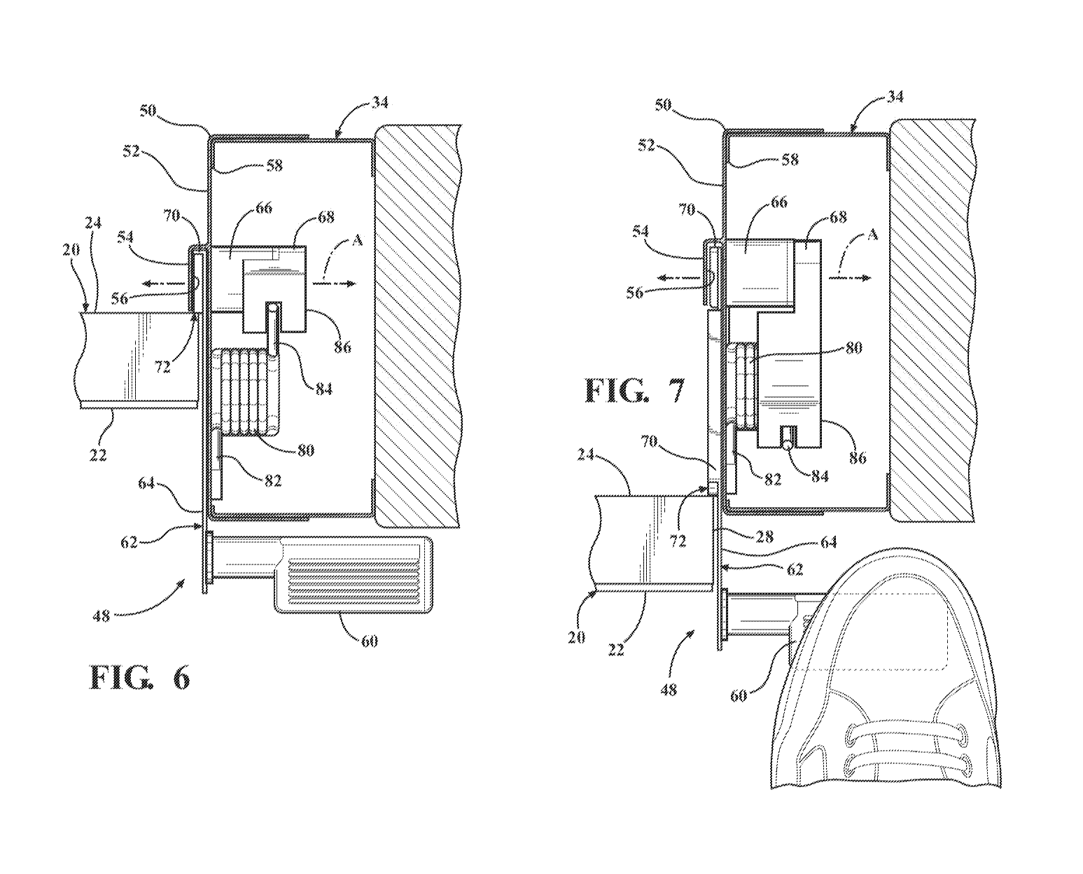

In the example of retrofit installation applications (FIGS. 1-12), the assembly 48 may include a mounting bracket 50. The mounting bracket 50 can take a variety of forms, and in the illustrated examples includes a jamb face extension 52 generally aligned with the jamb face 42 of the door frame 34. The mounting bracket 50 also includes a stop strip extension 54 generally aligned with the stop strip 44 of the door frame. In other words, the mounting bracket may be designed to blend harmoniously with the existing contours and features of the swing side 38 of the frame 34. The stop strip extension 54 has an abutment plane extension that generally aligns with the abutment plane of the stop strip 44, as perhaps best shown in FIGS. 6 and 7.

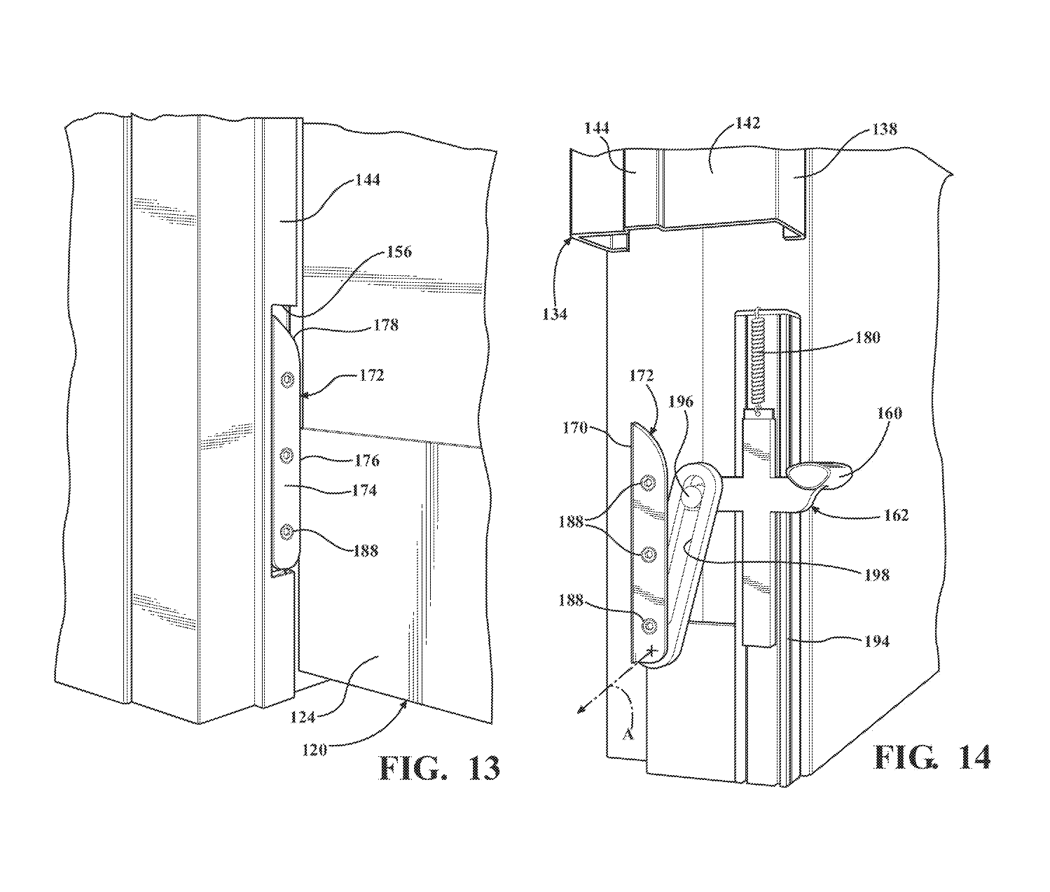

The stop strip extension 54 defines a pocket 56. The pocket 56 is at least partially enclosed by the stop strip extension 54. As will be described below, in alternative applications that omit or utilize a modified form of mounting bracket 50, the pocket 56 may be formed directly into the stop strip 44 of the swing side 38 door frame 34. The pocket 56 has an opening formed in the abutment plane and/or plane extension. In other words, the pocket 56 can be accessed via the region at which the door 20 engages the stop strip 44/stop strip extension 54. In the illustrated embodiment, the stop strip extension 54 is formed by an L-shaped member such that the pocket 56 extends substantially the full vertical length of the stop strip extension 54. Alternative embodiments are described below in connection with FIGS. 13, 14 and 17.

The mounting bracket 50 may be formed from a heavy gauge sheet stock having a generally uniform thickness, and formed into a C-shapes cuff that partially covers the lowermost section of the swing side 38 of the door frame 34. A cavity 58 may be cut or otherwise formed into the swing side 38 to accommodate the assembly 48. The mounting bracket 50 substantially covers the cavity 58 and presents a finished, protective cover.

The assembly 48 further includes a foot pedal 60. The foot pedal 60 is moveably supported by a linkage, generally indicated at 62. The linkage 62 controls movement of the foot pedal 60 so that it in use it reciprocates between a home position, wherein the foot pedal 60 is in an elevated condition, and an actuated condition, wherein the foot pedal 60 is depressed by a user's foot to a descended condition. The home position is shown in FIGS. 1, 4 and 6, whereas the actuated condition is shown in FIGS. 2, 3, 5 and 7. The following description advances several possible expressions of the linkage 62, it being understood that those described are mere examples and that many alternatives are possible. Those of skill in the art will appreciate a great many alternative linkage configurations that could be devised to accomplish similar functionality or results.

According to the first embodiment, the linkage 62 includes a spacer plate 64 disposed within an interstitial space between the swinging edge 28 of the door 20 and the jamb face extension 52 of the mounting bracket 50 when the door 20 is in the closed condition. This location of the spacer plate 64 is perhaps best shown in FIG. 6. The spacer plate 64 is preferably made from a very strong but thin material, such as stainless steel, so that it slips between the door 20 and frame 34 but does not bend in use. A first hinge part 66 is supported in the mounting bracket 50, which in turn directly interacts with a second hinge part 68 of the linkage 62. An imaginary, generally horizontal, pivot axis A is established via the interacting first 66 and second 68 hinge parts. The pivot axis A preferably passes through the jamb face extension 52, however alternative constructions could orient the pivot axis A laterally on either side of the jamb face extension 52. The linkage 62 may be formed with a lip 70 at the back edge of the spacer plate 64. When the foot pedal 60 is in the home position, the lip 70 is disposed in the pocket 56.

An actuator, generally indicated at 72, is operatively connected to the linkage 62. The actuator 72 is configured to impart movement to the door 20 in response to movement of the foot pedal 60 toward its actuated condition. The actuator 72 includes a strike pad 74 affixed to spacer plate 64 and backed by the lip 70. The strike pad 74 may be formed from a durable, non-marring material such as high-density nylon or any other suitable material. The strike pad 74 has a retracted condition corresponding to the home position of the foot pedal 60 and an extended condition corresponding to the actuated condition of the foot pedal 60. The strike pad 74 is shown in its retracted condition in FIGS. 1, 4 and 6, and in the extended condition in FIGS. 2, 3, 5 and 7. The strike pad 74 is disposed, at least partially but preferably entirely, in the pocket 56 when in the retracted condition. Conversely, the strike pad 74 is at least partially disposed outside the pocket 56 in the extended condition.

The strike pad 74 includes a leading face 76 disposed for direct engagement with the posterior side 24 of the door 20 adjacent its swinging edge 28 when the door 20 is in the closed position. A curved cam section 78 extends from the leading face 76. The cam section 78 rides against the posterior side 24 of the door as it is being forced open to affect a smooth, even transfer of energy to the door 20. As perhaps best shown in FIG. 6, the width of the strike pad 74 is preferably not greater than the generally uniform width of the stop strip 44/strip extension 54 so that it fits neatly inside the pocket 56. Likewise, the strike pad 74 preferably does not have a projection (relative to the jamb face 42/52) greater than the generally uniform projection of the stop strip 44/strip extension 54 so that it fits neatly inside the pocket 56. However, these are not inviolate limitations, and the strike pad 74 could be so designed to bulge out from a suitably reconfigured pocket 56.

A spring 80 is operatively disposed to automatically return the foot pedal 60 to its home position following actuation. The spring 80 can take the form of perhaps any form of biasing element, but is shown in FIGS. 6, 7, 9 and 10 as a torsion-type spring. The spring 80 includes two legs 82, 84. One of the legs 82 is tack-welded or otherwise anchored to an inside surface of the mounting bracket 50. The other leg 84 is engaged by a short crank 86 that is carried on a shaft portion of the second hinge part 68 at the pivot axis A and that moves in concert with the linage 62. Rotary movement of the linkage 62 and actuator 72 causes a corresponding movement of the crank 86. This in turn loads the spring 80. When a user removes their foot from the foot pedal 60, the energy stored in the spring 80 unloads, automatically returning the foot pedal 60 to its home position and the strike pad 74 to its retracted position concealed inside the pocket 56.

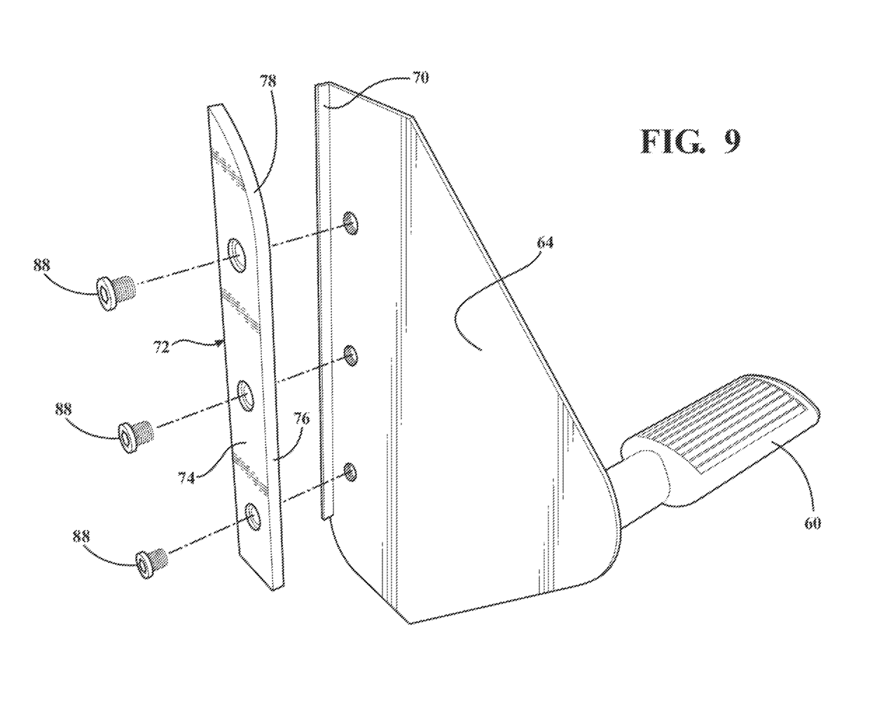

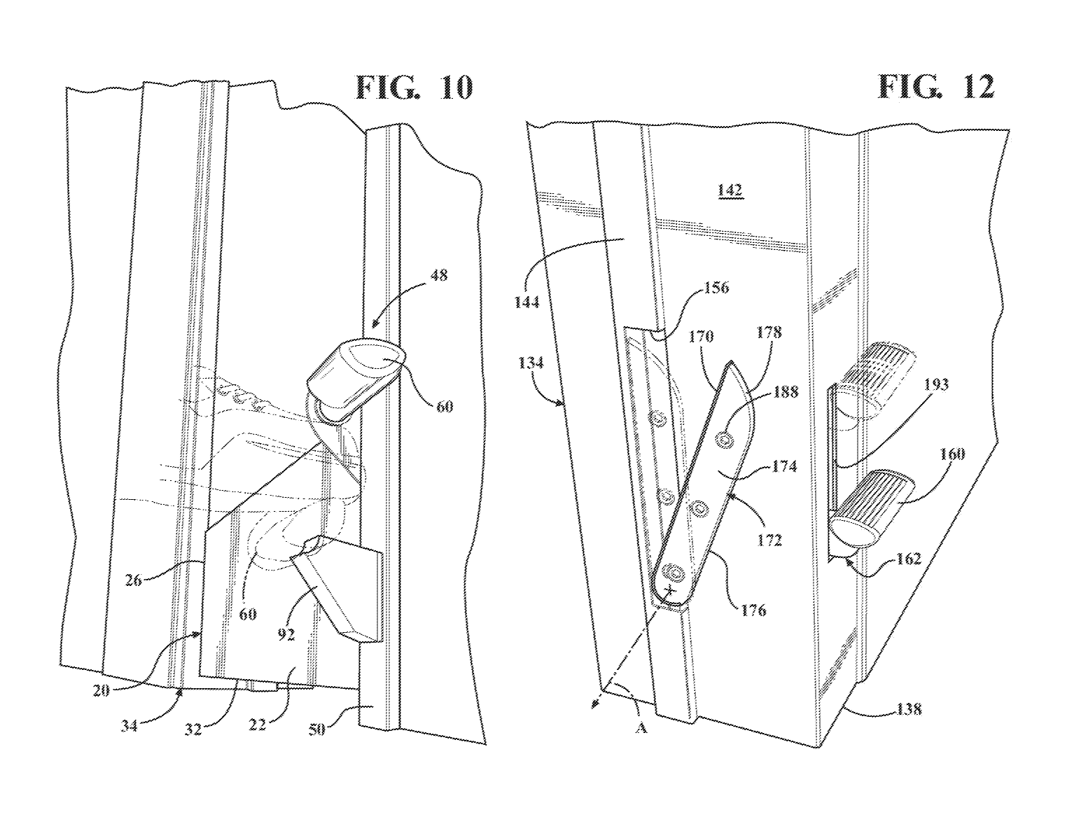

FIG. 9 shows that the strike pad 74 can be interconnected to the linkage 62 with one or more fasteners 88 to permit convenient replacement of the strike pad 74 as a wear component. If marring or scratching is a concern, a high-lubricity rub strip 90 can be disposed on the jamb face extension 52 or on the opposing face of the spacer plate 64. As shown in FIG. 10, an optional bumper 92 can be mounted to the frame 34 to engage the foot pedal 60 at its fully actuated down stroke. This will provide a soft but solid feel to a user that the foot pedal 60 has been fully displaced and as a tactile signal to discontinue foot pressure. The bumper 92 could alternatively be mounted to the foot pedal 60 or relocated to internal features such as on or near the hinge parts 66, 68.

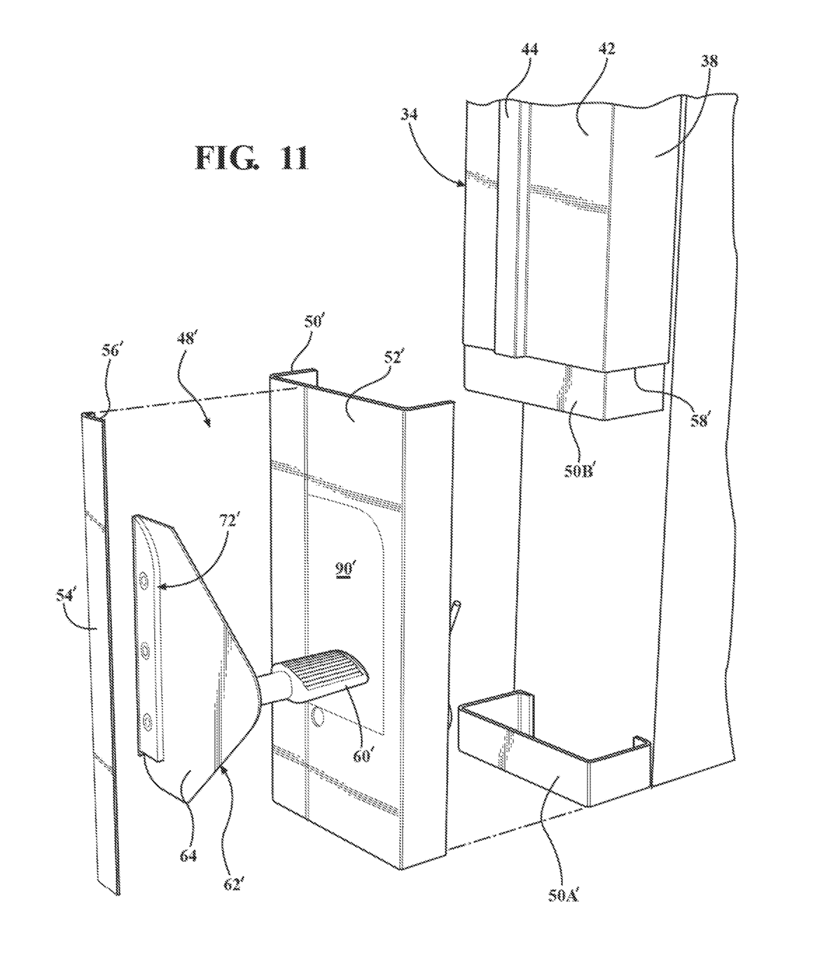

FIG. 11 is an exploded view of a second alternative embodiment of the invention similar in most respects to the previously described embodiment but in the form of a flush mounting design. For convenience, features corresponding directly to those described above in connection with the first embodiment are identified by like reference numbers accompanied by prime designations. In this example, the mounting bracket 50′ is reconfigured for ease of installation and to achieve a flush final appearance with respect to the swing side 38′ of the door frame 34′. During installation, the lowermost portion of the swing side 38′ is completely removed such as by cutting with a saw or rotary grinder. Mounting sub-base 50A′ is affixed to the wall and/or floor, while mounting sub-base 50B′ is affixed to the swing side 38′ and/or wall. Standard carpentry screws (not shown) can be used to quickly and securely anchor the mounting sub-bases 50A′, 50B′ in position. The outer dimensions of mounting sub-bases 50A′, 50B′ are sized, together with the cuff-like mounting bracket 50′, to allow the jamb face extension 52′ to align with the jamb face 42′ of the frame 34′, and the respective casing sides to align as well thus creating a refined final appearance. With this design, a skilled technician can quickly retrofit an existing door frame using suitable cutting jigs and installation tools to achieve a visually pleasing result.

Turning now to FIGS. 12-15, a third alternative embodiment of the present invention is depicted. For convenience, features corresponding directly to those described above in connection with the first embodiment are identified by like reference numbers offset by 100. In this third embodiment, three modifications will be observed relative to the first embodiment. Firstly, the linkage 162 is reconfigured to establish guided linear movement of the foot pedal 160 between its home and actuated conditions. Secondly, the assembly 148 is disposed within a hollow door frame 134. I.e., there is no cuff-like mounting bracket per se, but instead the mounting bracket is internal to the door frame 134. Lastly, the pocket 156 is formed by removing a section in the stop strip 144. The third embodiment offers a sleek, integrated appearance. As shown in FIG. 12, a slot 193 may be formed in the door frame 134 for the linkage 162 to pass between the foot pedal 160 and the hollow frame interior.

With respect to the reconfiguration of the linkage 162 to establish guided linear movement of the foot pedal 160. FIGS. 14 and 15 are offered as one exemplary implementation. A slide mechanism 194 is housed inside the hollow frame 134, and includes a follower or roller 196. The follower 196 is captured in a cam slot 198, which in turn is fixed relative to the actuator 172. As the foot pedal 160 travels up and down, the follower 196 sliding within the cam slot 198 forces the actuator 172 to pivot about the pivot axis A. An extension spring 180 automatically returns the foot pedal 160 to its home position. In this configuration, the mounting bracket would include the portions of the slide mechanism 194 and other features that anchor the opener assembly to the wall and/or frame 134.

A particular advantage of the guided linear movement of the foot pedal 160 is improved overall compactness of the assembly 148. The constrained vertical motion allows the foot pedal 160 to be located relatively close to the wall or door frame 134, which in turn means less protrusion into walking spaces. Another significant advantage is that vertical motion is sometimes considered to be more user friendly than pivotal pedal travel.

One advantage of the reconfigured pocket 156 is that the strike pad 174 can be slightly wider if desired to provide better engagement with the door 20. The strike pad 174 could, if desired, be made to protrude out from the pocket 156 and more than the stop strip 144.

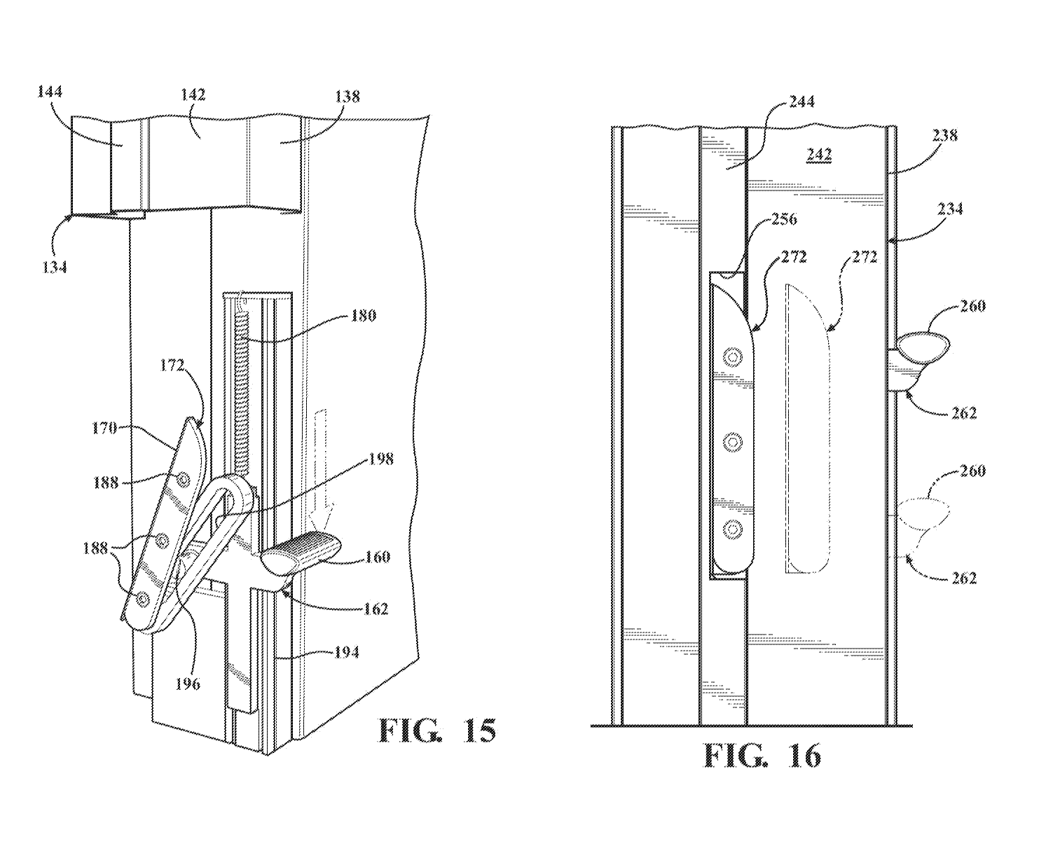

FIG. 16 represents a fourth alternative embodiment of the present invention. For convenience, features corresponding to those described in connection with the third embodiment are identified by like reference numbers offset by 200. In this embodiment the linkage 262 is re-engineered to translate the actuator 272 rather than pivot it between retracted and extended positions. Although several different mechanical arrangements could be used to accomplish this conversion of vertical pedal 260 motion to horizontal strike pad 274 motion, contemplated methods include a rack and pinion system and a cam slider system. In both contemplated systems, the actuator 272 is supported on a horizontal sliding track. A rack and pinion system could include the formation of a rack gear on each of the foot pedal 260 and actuator 272, with a pinion gear simultaneously engaging both rack gears. A cam slider system, by contrast, cold include the formation of an angular cam slot in the actuator 272, which in turn is supported on previously mentioned horizontal sliding track. In this manner, the foot pedal 260 and associated linkage 262 mechanism could be similar in many respects to the design shown in FIGS. 15 and 16. Those of skill in the art will also envision other motions of the actuator 272, which may include curvilinear translation and other general plane motions such as can be accomplished with four-bar linkages, worm drives, various gearing, wedges, and many other mechanical configurations.

The foregoing invention has been described in accordance with the relevant legal standards, thus the description is exemplary rather than limiting in nature. Variations and modifications to the disclosed embodiment may become apparent to those skilled in the art and fall within the scope of the invention. For example, features described in connection with particular embodiments can be intermixed and substituted with the features of one or more other embodiments to achieve new combinations of door opener assemblies within the spirit of this invention.

What is claimed is:

1. A foot-operated sanitary door opener assembly for a door of the type supported in a door frame for swinging movement between open and closed conditions, said assembly comprising:
a stop strip,
a foot pedal moveably supported relative to said stop strip, said foot pedal having a home position wherein said foot pedal is elevated and an actuated condition wherein said foot pedal is descended relative to said home position,
a strike pad operatively connected to said foot pedal, said strike pad configured to impart movement to said door in response to movement of said foot pedal, said strike pad having a retracted condition corresponding to said home position of said foot pedal and an extended condition corresponding to said actuated condition of said foot pedal, and
said stop strip extension defining a pocket, said strike pad disposed in said pocket in said retracted condition, and said strike pad at least partially disposed outside said pocket in said extended condition.

2. The assembly of claim 1 wherein said pocket is at least partially enclosed by said stop strip.

3. The assembly of claim 1 wherein said strike pad includes a leading face disposed for direct engagement with said posterior side of said door adjacent said swinging edge thereof when said door is in a closed position, and said strike pad has a curved cam section extending from said leading face.

4. The assembly of claim 1 wherein said stop strip has a generally uniform width, and said strike pad has a width not greater than the generally uniform width of said stop strip.

5. The assembly of claim 1 further including a jamb face, said stop strip has a generally uniform projection relative to said jamb face, and said strike pad has a projection relative to said jamb face not greater than said generally uniform projection of said stop strip.

6. The assembly of claim 1 wherein said foot pedal includes a linkage operatively interconnecting with said strike pad, said linkage establishing guided linear movement of said foot pedal between said home and actuated conditions.

7. The assembly of claim 1 wherein said foot pedal includes a linkage operatively interconnecting with said strike pad, said linkage establishing guided non-linear movement of said foot pedal between said home and actuated conditions.

8. The assembly of claim 1 farther including a spring operatively disposed between said stop strip and said foot pedal, said spring biasing said foot pedal toward said home position.

9. The assembly of claim 1 farther including a rub strip disposed on said jamb face.

10. The assembly of claim 1 wherein said foot pedal includes a linkage operatively interconnecting with said strike pad, said linkage includes a lip disposed in direct engagement with said strike pad, said lip disposed in said pocket when said foot pedal is in said home position.

11. The assembly of claim 1 wherein said foot pedal includes a linkage operatively interconnecting with said strike pad, further including at least one fastener interconnecting said strike pad and said linkage to permit replacement of said strike pad.

12. The assembly of claim 1 further including a mounting bracket configured for attachment directly to a door frame, said mounting bracket including a stop strip extension aligning with said stop strip, said linkage at least partially supported on said mounting bracket.

13. The assembly of claim 12 wherein said stop strip extension has a vertical height, and wherein said pocket extends substantially the full vertical height of said stop strip extension.

14. A foot-operated sanitary door frame assembly, said assembly comprising:
a door frame configured to support a door for swinging movement between open and closed conditions, said door frame including a generally vertical swing side adjacent a swinging edge of the door, said swing side of said door frame including a generally vertically extending jamb face, a stop strip disposed along said jamb face,
a foot pedal, said foot pedal including a linkage moveably supported relative to said swing side of said door frame, said foot pedal having a home position wherein said foot pedal is elevated and an actuated condition wherein said foot pedal is descended relative to said home position,
a strike pad operatively connected to said linkage, said strike pad configured to impart movement to the door in response to movement of said foot pedal, said strike pad having a retracted condition corresponding to said home position of said foot pedal and an extended condition corresponding to said actuated condition of said foot pedal, and
a pocket at least partially enclosed by said stop strip, said strike pad disposed in said pocket in said retracted condition, and said strike pad at least partially disposed outside said pocket in said extended condition.

15. The assembly of claim 14 further including a door supported in said door frame for swinging movement between open and closed conditions, said swing side of said door frame including a generally vertically extending jamb face, said door being a generally rectangular body having an anterior side and an opposite posterior side, said rectangular body defined by a generally vertical hinge edge, a generally vertical swinging edge, a generally horizontal top edge and a generally horizontal bottom edge, and wherein said door frame includes a generally vertical hinge side adjacent said hinge edge of said door, said stop strip establishing an abutment plane, said stop strip having a generally uniform width, said stop strip having a generally uniform projection from said jamb face, and at least one door hinge operatively disposed between said hinge side of said door frame and said hinge edge of said door, said door hinge cooperating to support said door in said frame for pivotal movement toward and away from the closed condition in which said posterior side of said door is generally aligned with said abutment plane of said stop strip and said swinging edge of said door is in direct contact with said stop strip, and wherein said linkage is at least partially disposed within an interstitial space between said swinging edge of said door and said jamb face when said door is in said closed condition.

16. The assembly of claim 14 wherein said linkage establishes guided linear movement of said foot pedal between said home and actuated conditions.

17. The assembly of claim 14 wherein said linkage establishes guided non-linear movement of said foot pedal between said home and actuated conditions.

18. The assembly of claim 14 further including a mounting bracket configured for attachment directly to said swing side of said door frame, said mounting bracket including a stop strip extension aligning with said stop strip, said linkage at least partially supported on said mounting bracket.

19. A foot-operated sanitary door opener assembly for a door of the type supported in a door frame for swinging movement between open and closed conditions, said assembly comprising:
a mounting bracket, said mounting bracket configured to attach to the swinging side of a door frame,
a foot pedal moveably supported relative to said mounting bracket, said foot pedal having a home position wherein said foot pedal is elevated and an actuated condition wherein said foot pedal is descended relative to said home position,
a strike pad operatively connected to said foot pedal, said strike pad configured to impart movement to said door in response to movement of said foot pedal, said strike pad having a retracted condition corresponding to said home position of said foot pedal and a extended condition corresponding to said actuated condition of said foot pedal, and
a linkage interconnecting said strike pad and said foot pedal said linkage establishing linear reciprocating movement of said foot pedal between said home and actuated conditions.

20. The assembly of claim 19 wherein said linkage includes a vertically disposed slide mechanism.
